(19) United States
(12) Patent Application Publication
(10) Pub. No.: US 2020/0167123 A1
(43) Pub. Date: May 28, 2020

(54) AUDIO SYSTEM FOR FLEXIBLY CHOREOGRAPHING AUDIO OUTPUT

(71) Applicant: Creative Technology Ltd, Singapore (SG)

(72) Inventors: Wong Hoo SIM, Singapore (SG); Yam Fei LIAN, Singapore (SG)

(73) Assignee: Creative Technology Ltd, Singapore (SG)

(21) Appl. No.: 16/775,082

(22) Filed: Jan. 28, 2020

Related U.S. Application Data
(63) Continuation of application No. 16/060,015, filed on Jun. 6, 2018.

(30) Foreign Application Priority Data
Dec. 7, 2015 (SG) 10201510013T
May 24, 2016 (SG) 10201604137Q
Aug. 11, 2016 (SG) 10201606668T
Nov. 9, 2016 (SG) PCT/SG2016/050556

(51) Int. Cl. G06F 3/16; G11B 27/34; G11B 27/031; G06F 3/0486

(52) U.S. Cl. CPC G06F 3/165; G06F 3/0486; G11B 27/031; G11B 27/34

(57) ABSTRACT

There is provided an audio system which can include an apparatus (e.g., a soundbar) and a computer. The apparatus can include a plurality of speaker drivers. Additionally, the computer can be coupled to the apparatus. The computer can be configured to present a user interface and a suite of audio effects. The suite of audio effects and the user interface can be used for flexibly choreographing audio output (i.e., of a data file) from the apparatus.

### CROSS REFERENCES TO RELATED APPLICATIONS

This Application is a Continuation of U.S. application Ser. No. 16/060,015, filed 6 Jun. 2018, and titled “AN AUDIO SYSTEM FOR FLEXIBLY CHOREOGRAPHING AUDIO OUTPUT”, which is a National Stage (§ 371) of International Application Number: PCT/SG2016/050591, filed 5 Dec. 2016, and titled “AN AUDIO SYSTEM”, which claims the benefit of priority from International Application: PCT/SG2016/050556, filed 9 Nov. 2016, and titled “A SOUNDBAR”, which claims the benefit of priority from Singapore Application: 10201510013T, filed 7 Dec. 2015, and titled “A SOUNDBAR”, and Singapore Application: 10201606668T, filed 11 Aug. 2016, and titled “AN APPARATUS FOR CONTROLLING LIGHTING BEHAVIOR OF A PLURALITY OF LIGHTING ELEMENTS AND A METHOD THEREFORE”, which claims the benefit of priority from Singapore Application: 10201604137Q, filed 24 May 2016, and titled “AN APPARATUS FOR CONTROLLING LIGHTING BEHAVIOR OF A PLURALITY OF LIGHTING ELEMENTS AND A METHOD THEREFORE”, the entirety of each of which are incorporated by reference for all purposes.

### FIELD OF INVENTION

The present disclosure generally relates an audio system which allows a user to flexibly choreograph audio output.

### BACKGROUND

While listening to music playback, it is appreciable that there could be certain parts of the playback which may be audibly jarring to a listener and certain parts which the listener might prefer more emphasis/wish to be associated with a different audio effect. This is particularly so when the music playback is of considerable duration and the music may be of a genre (e.g., classical/orchestra type music) which could, for example, feature extreme variations in audio output (e.g., highs and lows in output volume).

Appreciably, the listener may need to make manual adjustments during the course of playback to suite his/her preference(s). For example, in certain parts of the playback where the audio output is too loud, the listener may have to manually lower the volume and in certain parts of the playback where the audio output is too soft, the listener may have to manually increase the volume.

The need for manual adjustment(s) by the listener may detract listening experience.

It is therefore desirable to provide a solution to address the foregoing problem.

### SUMMARY OF THE INVENTION

In accordance with an aspect of the disclosure, there is provided an audio system.

The audio system can include an apparatus (e.g., a soundbar) and a computer. The apparatus can include a plurality of speaker drivers. Additionally, the computer can be coupled to the apparatus.

The computer can be configured to present a user interface and a suite of audio effects. The suite of audio effects and the user interface can be used for flexibly choreographing audio output (i.e., of a data file) from the apparatus.

In one embodiment, the user interface can be configured to display a representation of the data file and the representation can be in the form of a timeline bar. Additionally, the suite of audio effects can include one or more audio effects which can be visually presented as corresponding one or more audio effect labels. Specifically, an audio effect can be visually presented as an audio effect label.

Each of the audio effect labels can be flexibly inserted (i.e., by a user) at any point in time within/of the timeline bar, thereby facilitating flexible choreography of audio output from the apparatus.

### BRIEF DESCRIPTION OF THE DRAWINGS

Embodiments of the disclosure are described hereinafter with reference to the following drawings, in which:

FIG. 1a shows a soundbar having a casing, according to an embodiment of the disclosure;

FIG. 1b shows that the casing of the soundbar of FIG. 1a can be shaped and dimensioned in a manner so as to carry a plurality of speaker drivers and a processing portion within the casing, according to an embodiment of the disclosure;

FIG. 1c shows that one of the sides of the casing of FIG. 1a can be shaped and dimensioned to carry a user control portion and an interface portion, according to an embodiment of the disclosure;

FIG. 1d shows that one of the sides of the casing of FIG. 1a can be shaped and dimensioned to carry a connection portion, one or more transmission portions and one or more mounting portions, according to an embodiment of the disclosure;

FIG. 1e shows the connection portion of FIG. 1d in further detail, according to an embodiment of the disclosure;

FIG. 2 shows the interface portion of FIG. 1c in further detail, according to an embodiment of the disclosure;

FIG. 3 shows the processing portion of FIG. 1b in further detail where the processing portion can include an audio module, according to an embodiment of the disclosure;

FIG. 4 shows the audio module of FIG. 3 in further detail where the audio module can include a primary audio processor, an intermediate audio processor and a secondary audio processor, according to an embodiment of the disclosure;

FIG. 5 shows that the secondary audio processor of FIG. 4, which can be referred to as a control processor, can be configured to perform one or more tasks so as to, in one exemplary application, generate one or more sound fields, according to an embodiment of the disclosure;

FIG. 6 shows an exemplary setup, in association with the soundbar of FIG. 1a, for generating one or more sound fields, according to an embodiment of the disclosure;

FIG. 7 illustrates a convex speaker arrangement and a concave speaker arrangement in association with the exemplary setup of FIG. 6, according to an embodiment of the disclosure; and

FIG. 8 shows that the soundbar of FIG. 1 can be coupled to a computer, according to an embodiment of the disclosure.

### DETAILED DESCRIPTION

The present disclosure relates to a soundbar with elevation channel speakers which provide an extra dimension of height to user audible perception in addition to surround sound experience. The soundbar can, for example, be coupled (wirelessly and/or wired coupling) to a subwoofer so as to enhance audible perception of low frequency audio signals (i.e., bass). Moreover, the soundbar can be coupled to a computer for flexible control/adjustment of one or more data files (e.g., audio type files such as MP3 and WMA files) played back by the soundbar.

Moreover, the soundbar can be configured to support a variety of Wi-Fi audio based protocol (e.g., “Airplay” developed by Apple Inc. and “Goggle Cast” developed by Google Inc.). Additionally, the soundbar can be configured to support music streaming services such as “Spotify” and “TuneIn”.

Furthermore, the soundbar can be configured so as to be usable as a Karaoke device. The soundbar can be configured to be capable of performing/supporting other audio related functions such as voice control.

In addition to audio related function(s) discussed above, the soundbar can be configured to be capable of supporting video related function(s). Specifically, the soundbar can be configured to support video playback from online sources such as “Netflix,” “Hulu plus” and “HBO Go”.

Therefore, the soundbar can be capable of one or both of audio related function(s) and video related function(s). Moreover, the soundbar can be capable of allowing/facilitating user storage of content.

As such, it is appreciable that the soundbar can be a user friendly device which serves as a sound, video and storage hub.

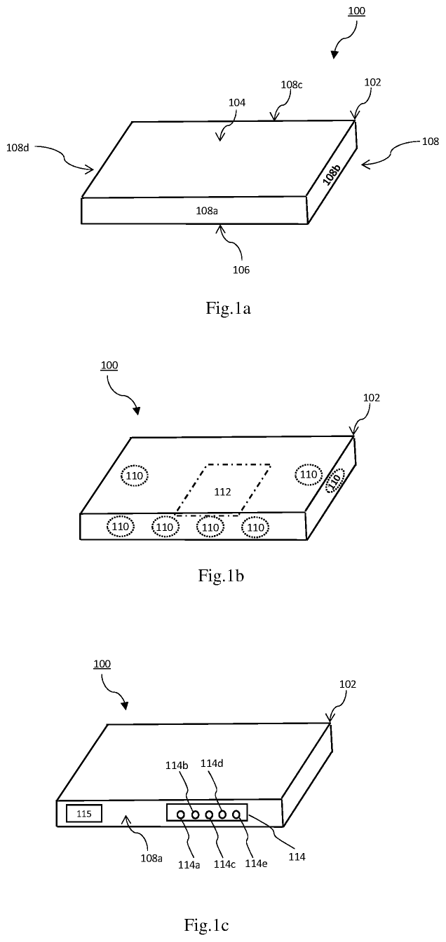

The soundbar will be discussed hereinafter with reference to FIG. 1 to FIG. 8. Additionally, the soundbar can simply can referred to as an apparatus.

Referring to FIG. 1a, a soundbar 100 is shown is accordance with an embodiment of the disclosure. The soundbar 100 can include a casing 102 which includes a first face 104, a second face 106 and sides 108. The first and second faces 104/106 can be opposite each other and spaced apart such that the sides 108 are formed between the first and second faces 104/106. As such, the sides 108 can, for example, include a first side 108a, a second side 108b, a third side 108c and a fourth side 108d. The first side 108a and the third side 108c can be opposite sides whereas the second side 108b and the fourth side 108d can be opposite sides.

In an exemplary orientation of the soundbar 100, the first face 104 can be considered to be the top of the soundbar 100, the second face 106 can be considered to be the bottom of the soundbar 100, the first side 108a can be considered to be the front of the soundbar 100, the second side 108b can be considered to be the right side of the soundbar 100, the third side 108c can be considered to be the back of the soundbar 100, the fourth side 108d can be considered to be the left side of the soundbar 100.

Referring to FIG. 1b, FIG. 1c, FIG. 1d and FIG. 1e, the casing 102 can be shaped and dimensioned to carry one or more speaker drivers 110, a processing portion 112, a user control portion 114, an interface portion 115 and a connection portion 116. Additionally, the casing 102 can be shaped and dimensioned to carry one or more transmission portions 118 and/or one or more mounting portions 120.

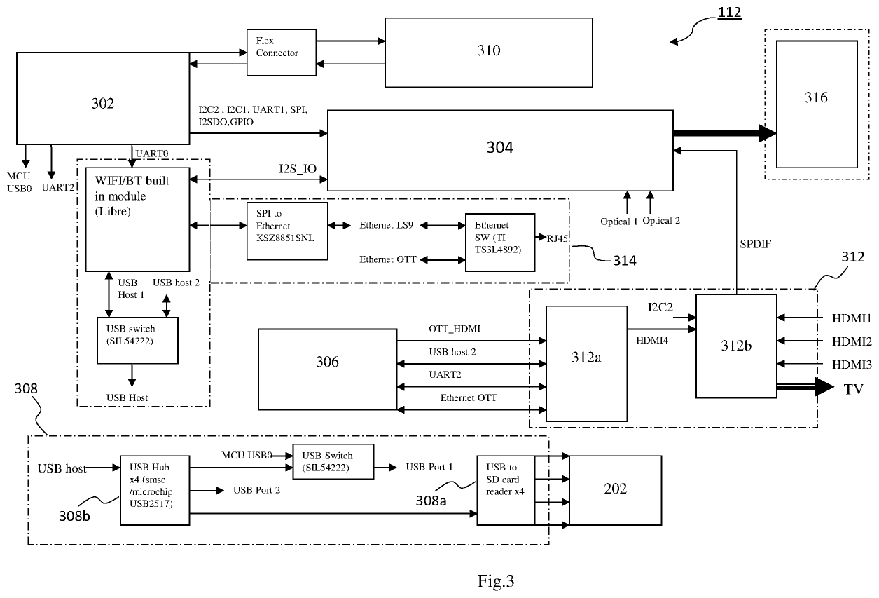

Specifically, FIG. 1b shows that the casing 102 can be shaped and dimensioned in a manner so as to carry the speaker drivers 110 and the processing portion 112 within (i.e., depicted by dotted lines) the casing 102, according to an embodiment of the disclosure. For example, although not explicitly shown in FIG. 1b, the casing 102 can be shaped and dimensioned in a manner so as to carry fifteen speaker drivers 110. The fifteen speaker drivers 110 can include a left channel speaker driver array having a “Mid-Tweeter-Mid” (MTM) configuration/a “Tweeter-Mid-Mid” (TMM) configuration (i.e., three speaker drivers 110), a right channel speaker driver array having a “Mid-tweeter-Mid” (MTM) configuration/a “Tweeter-Mid-Mid” (TMM) configuration (i.e., three speaker drivers 110), a center channel speaker driver array having a “Mid-Tweeter-Mid” (MTM) configuration (i.e., three speaker drivers 110), two additional channels having a “Mid-tweeter” (MT) speaker driver array configuration each (i.e., each channel having two speaker drivers 110) and yet further two channels having a full range speaker driver each (i.e., each channel having a speaker driver 110). In this regard, the fifteen speaker drivers can, for example, include eight mid-range speaker drivers (i.e., earlier mentioned “Mid”), five tweeters and two full range drivers. The processing portion 112 will be discussed later in further detail with reference to FIG. 3.

Additionally, it is preferable that the casing 102 can be shaped and dimensioned in a manner so that each of the speaker drivers 110 is housed within an individual chamber. For example, where there are fifteen speaker drivers 110, the casing 102 can include corresponding fifteen chambers and each speaker driver 110 can be carried by/housed within a corresponding chamber. Hence the speaker drivers 110, each being housed within an individual chamber, can be acoustically isolated from each other.

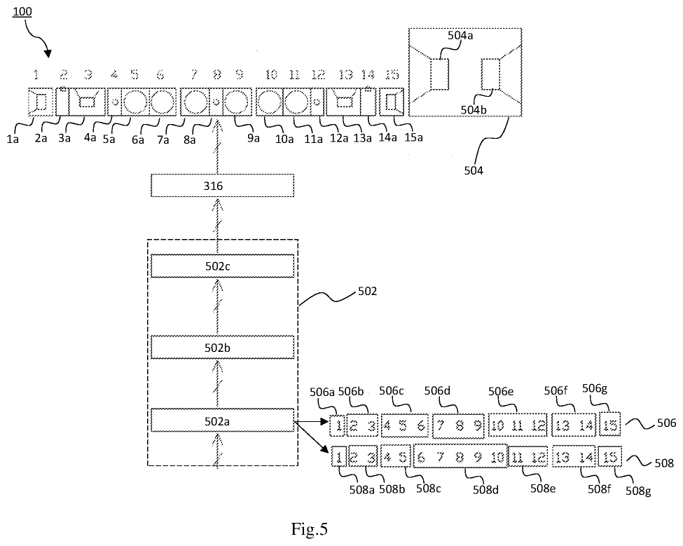

Moreover, it is preferable that the speaker drivers 110 can be individually controlled by the processing portion 112. This will be discussed later in further detail with reference to FIG. 5.

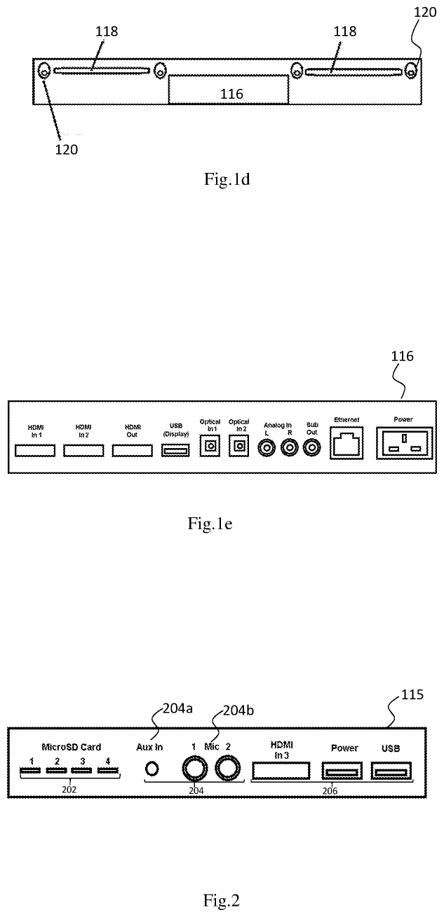

FIG. 1c shows that one of the sides 108 of the casing 102 can be shaped and dimensioned to carry the user control portion 114 and the interface portion 115, according to an embodiment of the disclosure. For example, the user control portion 114 and the interface portion 115 can be carried by the first side 108a of the casing. The user control portion 114 can be visually perceived and accessed by a user for the purpose of, for example, controlling the soundbar 100. As shown, the user control portion 114 can, for example, include a plurality of physical buttons such as a first push type button 114a, a second push type button 114b, a third push type button 114c, a fourth push type button 114d and a fifth push type button 114e. The interface portion 115 can include a receiver portion (not shown) for receiving command signals (e.g., infra-red signals from a remote control). The interface portion 115 will be discussed later in further detail with reference to FIG. 2.

FIG. 1d shows that one of the sides 108 of the casing 102 can be shaped and dimensioned to carry the connection portion 116, one or more transmission portions 118 and one or more mounting portions 120, according to an embodiment of the disclosure. For example, the connection portion 116 can be carried by the third side 108c of the casing 102, and the casing 102 can be shaped and dimensioned so that the third side 108c can include a recessed bay within which the connection portion 116 can be carried. Moreover, the mounting portion(s) 120 can correspond to wall mount keyhole(s) facilitating the possibility of wall mounting the soundbar 100. Wall mounting of the soundbar 100 can, for example, be in accordance with VESA (i.e., Video Electronics Standards Association) Mounting Interface Standard (MIS). Appreciably, the recessed bay allows connected cables to remain out of sight (e.g., for aesthetic purposes) and, at the same time, facilitate the possibility of wall mounting of the soundbar 100.

The present application contemplates the possibility of the soundbar 100 physically blocking, for example, the Infra-Red (IR) receiver of an electronic device (e.g., a television) to which the soundbar 100 is paired. For example, the soundbar 100 could be used (i.e., paired) with a television and when the soundbar 100 and the television are placed together on a console, the television's IR receiver could be blocked by the soundbar 100. In this regard, the transmission portion 118 can be configured to retransmit any IR signals (e.g., communicated from the television's remote controller) received by the soundbar's 100 receiver portion at the interface portion 115 so that the device (e.g., television) paired with the soundbar 100 can still be remotely controlled (i.e., by the remote controller of the television).

The connection portion 116 can be visually perceived and accessed by a user for the purpose of, for example, connecting one or more peripheral devices to the soundbar 100. Appreciably, connection of peripheral device(s) to the soundbar 100 via the connection portion 116 can be via wired connection. An example of a peripheral device which can be connected to the soundbar 100 can be the aforementioned television. The connection portion 116 will be shown and discussed in further detail with reference to FIG. 1e.

As shown in FIG. 1e, the connection portion 116 can include, for example, “Optical in” type connectors, “High Definition Multimedia Interface” (HDMI) type connectors, “Universal Serial Bus” (USB) type connector(s), an Ethernet connector, a 4 pole 3.5 mm Analog subwoofer out connector, RCA (Radio Corporation of America) type connectors and a IEC C14 power connector. The HDMI type connector(s) can, for example, include 2.0 A input type HDMI connector(s) supporting HDCP 2.2 for cabled devices and 2.0 A type HDMI type output connector(s) supporting audio return channel (ARC). The HDMI connector(s) can be used for connection to, for example, the aforementioned television. The USB type connector(s) can include a USB Host port for connection of an external display to the soundbar 100. The RCA connectors (i.e., “Analog In L R” in FIG. 1e) can be used for stereo analog inputs and the 4 pole 3.5 mm analog subwoofer out connector (i.e., “Sub Out” in FIG. 1e—for connection to a subwoofer device) can be used as a backup in Radio Frequency hostile environments.

Earlier mentioned, one of the sides 108 of the casing 102 can be shaped and dimensioned to carry the interface portion 115. The interface portion 115 will be discussed in further detail with reference to FIG. 2 hereinafter.

As shown in FIG. 2, the interface portion 115 can include a memory input portion 202, an analog input portion 204 and a digital input portion 206.

The memory input portion 202 can include one or more input slots for insertion of corresponding one or more memory devices such as memory cards/sticks. One example of a memory card is a secure digital card (i.e., SD card). Another example of a memory card is a micro SD card. As shown, the memory input portion 202 can, for example, include a first input slot (i.e., “MicroSD Card 1” in FIG. 2), a second input slot (i.e., “MicroSD Card 2” in FIG. 2), a third input slot (i.e., “MicroSD Card 3” in FIG. 2) and a fourth input slot (i.e., “MicroSD Card 4” in FIG. 2) for insertion of a first micro SD card, a second micro SD card, a third micro SD card and a fourth micro SD card respectively. The memory input portion 202 can facilitate user storage of content. Therefore, the soundbar 100 can be capable of allowing/facilitating user storage of content.

Preferably, the memory input portion 202 can be configured to have passcode control for either allowing or impeding access to content stored within the memory device(s). More preferably, passocde control can allow one or more of the memory devices “visible” and accessible provided that the correct passcode is provided.

The analog input portion 204 can include an auxiliary input portion 204a and a voice input portion 204b. The auxiliary input portion 204a can, for example, be in the form of a 3.5 mm female connector able to receive a jack. Similarly, the voice input portion 204b can, for example, include one or more connectors, each being in the form of a 3.5 mm female connector able to receive a jack.

The auxiliary input portion 204a can facilitate wired connection of the soundbar 100 to another audio device (not shown). The audio device (e.g., portable audio player) can communicate audio signals to the soundbar 100 which can act as a speaker for the audio device.

The voice input portion 204b can, for example, a first microphone input (i.e., “Mic 1” in FIG. 2) and a second microphone input (i.e., “Mic 2” in FIG. 2). Each of the microphone inputs can be used for receiving voice inputs from one or more users. In this regard, it is appreciable that the soundbar 100 can be used as a Karaoke device is desired. Further appreciably, if desired, the soundbar 100 can be capable of performing/supporting other audio related functions such as voice control.

The digital input portion 206 can include one or both of USB type connector(s) and HDMI type connector(s). As shown, the digital input portion 206 can, for example, include a HDMI type connector (i.e., “HDMI In 3” in FIG. 2), a power USB type connector (i.e., “Power” in FIG. 2) for supplying power to a peripheral device which may be plugged to the soundbar 100 via the “Power” USB type connector and a host USB type connector (“USB” in FIG. 2) for connection to, for example, a display device (e.g., a display screen) or additional an thumb drive/a hard disk.

Earlier mentioned, the casing 102 can be shaped and dimensioned in a manner so as to carry the processing portion 112. The processing portion 112 will be discussed in further detail hereinafter with reference to FIG. 3.

Referring to FIG. 3, the processing portion 112 can include a processor 302, an audio module 304, a video module 306, a memory module 308, a user interface module 310, an input/output (I/O) module 312, a transceiver module 314 and a speaker driver module 316.

The processor 302 can be coupled to each of the audio module 304, the video module 306, the memory module 308, the user interface module 310, the I/O module 312 and the transceiver module 314.

Specifically, the processor 302 can be coupled to the audio module 304 via a communication channel (i.e., “I2C2, I2C1, UART1, SOT, I2SDO, GPIO” as shown in FIG. 3). The processor 302 can be coupled to the video module 306 via another communication channel (i.e., “UART 2” as shown in FIG. 3). The processor 302 can be coupled to the memory module 308 via a connection (i.e., “MCU USB0” as shown in FIG. 3). The processor 302 can be coupled to the user interface module 310 via a connector (i.e., “Flex connector” as shown in FIG. 3). The processor 302 can be coupled to the I/O module 312 via a communication channel (i.e., “I2C2” as shown in FIG. 3). The processor 302 can be coupled to the transceiver module 314 via another communication channel (i.e., “UART 0” as shown in FIG. 3).

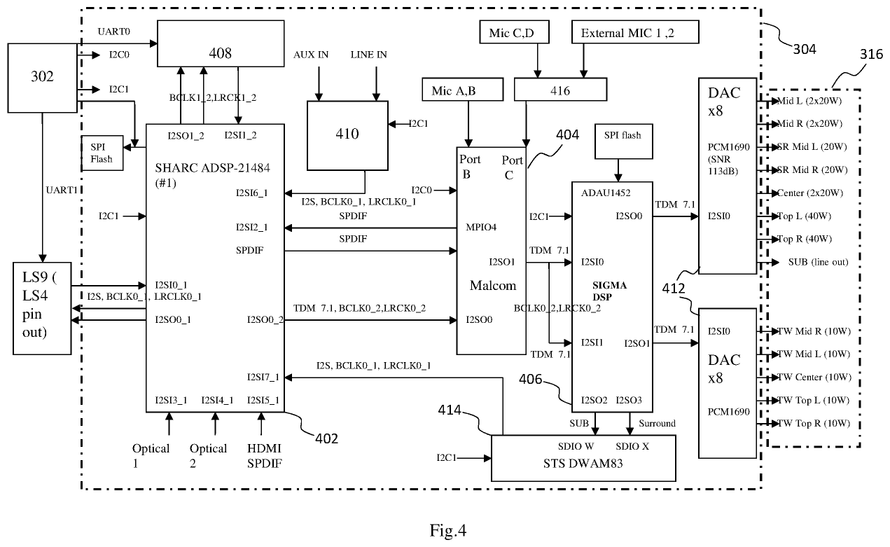

Furthermore, the audio module 304 can be coupled to the transceiver module 314 (i.e., “I2S IO” as shown in FIG. 3). The audio module 304 can be further coupled to the speaker driver module 316. The audio module 304 can yet be further coupled to the I/O module 312 via a communication channel (i.e., “SPDIF” as shown in FIG. 3). Moreover, one or both of at least a portion of the interface portion 115 and at least a portion of the connection portion 116 can be coupled to the audio module 304 as will be discussed later in further detail. The audio module 304 will be discussed later in further detail with reference to FIG. 4.

Additionally, the video module 306 can be coupled to the transceiver module 314 via one or more communication channels (i.e., “Ethernet OTT” and/or “USB host 2” as shown in FIG. 3). The video module 306 can be further coupled to the I/O module 312 via one or more communication channels (i.e., “OTT_HDMI, USB host 2, UART 2, Ethernet OTT” as shown in FIG. 3).

Moreover, the memory module 308 can be coupled to the transceiver module 314 via a connection (i.e., “USB Host” as shown in FIG. 3). The memory module 308 can be further coupled (not shown) to one or both of the audio module 304 and the video module 306.

Operationally, the processor 302 can, for example, be a microprocessor. The user interface module 310 can be coupled to the user control portion 114. For example, as a user interacts with any of the first to fifth push type buttons 114a/114b/114c/114d/114e, the user interface module 310 can be configured to detect which of the first to fifth push type button/buttons 114a/114b/114c/114d/114e has/have been pressed, and generate input signals accordingly. The input signals can be communicated to the processor 302 which can, in turn, generate control signals based on the input signals. The control signals can be communicated from the processor 302 to any of the audio module 304, the video module 306, the memory module 308, the user interface module 310, the I/O module 312 and the transceiver module 314, or any combination thereof. Specifically, control signals can be communicated from the processor 302 to the audio module 304, the video module 306, the memory module 308, the user interface module 310, the I/O module 312 and/or the transceiver module 314 via the appropriate connection(s) and/or communication channel/channels mentioned earlier.

Earlier mentioned, the soundbar 100 can be configured to support music streaming services and support video playback from online sources.

Such functions can be made possible by the transceiver module 314 which can be coupled to one or more online sources via a network (not shown).

In one example, in the case of audio streaming, the transceiver module 314 can be configured to communicate with an online music source (e.g., “Spotify”) and data from the online music source can be further communicated to the audio module 304 for further processing to produce audio output signals. The audio output signals can be communicated to the speaker driver module 316 which can correspond to, for example, an analog speaker amplifier. The speaker driver module 316 can be coupled to the aforementioned plurality of speaker drivers 110. In this regard, the speaker driver module 316 can be configured to amplify the audio output signals so that they can be audibly perceived by a user of the soundbar 100.

In another example, in the case of video streaming, the transceiver module 314 can be configured to communicate with an online video source (e.g., “Netflix”) and data from the online video source can be further communicated to the video module 306 for further processing to produce video output signals. The video module 306 can, for example, correspond to an “Over The Top” (OTT) Android based television module which can be coupled to a television set external to the soundbar 100. Specifically, the soundbar 100 can be coupled to a television set (not shown) to display the video output signals. The television set can be coupled to the video module 306 via the I/O module 312 (i.e., “TV” as shown in FIG. 3).

The I/O module 312 can be coupled to the connection portion 116. In this regard, the I/O module 312 can, for example, be HDMI based, and can include an interface port 312a and a HDMI processor 312b. It is appreciable that a peripheral device (not shown) can be coupled to the soundbar 100 and that data signals from the peripheral device can be communicated to the soundbar 100 via a HDMI connection (e.g., “HDMI 1”). For example, the peripheral device can be an audio signal generating device and audio signals generated can be communicated to the audio module 304 via a connection (i.e., “SPDIF” as shown in FIG. 3) between the I/O module 312 and the audio module 304. The audio module 304 can process the audio signals (from the peripheral device) to produce audio output signals which can be communicated to the speaker driver module 316. Similarly, output signals (e.g., video output signals) can be communicated from the soundbar 100 to a peripheral device connected to it. For example, a television set can be coupled to the soundbar 100 via the connection portion 116 (e.g., “HDMI out” as shown in FIG. 1e) and video output signals can be communicated via a signal line of the I/O module 312 (e.g., “TV” as shown in FIG. 3) coupled to, for example, “HDMI out” of the connection portion 116.

The memory module 308 can be coupled to the memory input portion 202 which can, for example, be in the form of a SD card slot module having a plurality of card slots. The memory module 308 can include a reader 308a (e.g., capable of reading the inserted SD card(s)). In one example, the memory input portion 202 can include four SD card slots. Therefore, the memory input portion 202 can carry four SD cards and the reader 308a can read up to four SD cards. The memory module 308 can also be coupled to the digital input portion 206 (e.g., USB type connector(s)). In this regard, the memory module 308 can further include a hub 308b such as a USB based hub.

Therefore, it is appreciable that one or more memory devices (e.g., USB sticks and/or SD cards) can be inserted to the soundbar 100 and content (e.g., audio based content and/or video based content) stored within the inserted memory device(s) can be read and communicated to one or both of the audio module 304 and the video module 306 for, for example, the purpose of playback.

The audio module 304 will be discussed in further detail with reference to FIG. 4 hereinafter.

In accordance with an embodiment of the disclosure, the audio module 304 can include a primary audio processor 402, an intermediate audio processor 404 and a secondary audio processor 406. In accordance with another embodiment of the disclosure, audio module 304 can further include a wireless communication module 408, an analog to digital converter (ADC) 410 and one or more digital to analog converters (DAC) 412. In accordance with yet another embodiment of the disclosure, the audio module 304 can yet further include one or both of a wireless audio module 414 and a multiplexer 416.

As shown, the primary audio processor 402 can be coupled to the intermediate audio processor 404. The intermediate audio processor 404 can be coupled to the secondary audio processor 406. The wireless communication module 408 and the ADC 410 can be coupled to the primary audio processor 402. The DAC(s) 412 can be coupled to the secondary audio processor 406. The wireless audio module 414 can be coupled to the primary audio processor 402 and the secondary audio processor 406. The multiplexer 416 can be coupled to the intermediate audio processor 404.

Additionally, the processor 302 can be coupled to the primary audio processor 402 and the DAC(s) 412 can be coupled to the speaker driver module 316. Furthermore, the processor 302 can be coupled to the wireless communication module 408.

Earlier mentioned, one or both of at least a portion of the interface portion 115 and at least a portion of the connection portion 116 can be coupled to the audio module 304.

In the case of the interface portion 115, the analog input portion 204 can be coupled to the audio module 304 in accordance with an embodiment of the disclosure. Specifically, the auxiliary input portion 204a and the voice input portion 204b can be coupled to the audio module 304. For example, the auxiliary input portion 204a can be coupled to the ADC 410 (“AUX IN” as shown in FIG. 4). The voice input portion 204b can be coupled to the intermediate audio processor 404 and/or the multiplexer 416 (“Mic A,B,” “Mic C, D” and “External MIC 1,2” as shown in FIG. 4). As an option, the multiplexer 416 can be configured to select voice input signals received from the voice input portion 204b (e.g., select between “Mic C, D” and External MIC 1, 2″ as shown in FIG. 4) and the selected voice input signals can be further communicated to the intermediate audio processor 404 for processing.

In the case of the connection portion 116, the “Optical in” type connector(s) and the HDMI type connector(s) can be coupled to the audio module 304 in accordance with an embodiment of the disclosure (e.g., connection of “Optical 1,” “Optical 2,” and HDMI″ to the primary audio processor 402 as shown in FIG. 4).

The primary audio processor 402 can, for example be Analog Device's “SHARC®” Processor for Dolby® Atmos®. The intermediate audio processor 404 can, for example, be “Malcolm chip+Recon3Di AP” from Creative Technology Ltd. The secondary audio processor 406 can, for example, be Analog Device's “SigmaDSP®” processor.

The wireless communication module 408 can, for example, be a Bluetooth based communication module for wireless streaming of, for example, audio signals from a peripheral device (e.g., Media player device) wirelessly paired with the soundbar 100.

The wireless audio module 414 can, for example, be configured to communicate with a subwoofer device (not shown) paired with the soundbar 100. Audio based output signals (e.g., “SUB” and “Surround” as shown in FIG. 4) can be communicated from the secondary audio processor 406 to the wireless audio module 414 which can further communicate the audio based output signals to a paired subwoofer device. As mentioned earlier, in Radio Frequency hostile environments and wired coupling is preferred, the 4 pole 3.5 mm analog subwoofer out connector (i.e., “Sub Out” in FIG. 1e—for connection to a subwoofer device) can be used. Moreover, control signals can be communicated (“I2C1” as shown in FIG. 4) from the processor 302 to control the wireless audio module 414.

Earlier mentioned, it is preferable that the speaker drivers 110 can be individually controlled by the processing portion 112. Specifically, the speaker drivers 110 can be individually controlled by the secondary audio processor 406 in accordance with an embodiment of the disclosure. It is appreciable that housing each of the speaker drivers 110 within an individual chamber (i.e., one speaker driver only per chamber) facilitates the possibility of individual control of the speaker drivers 110 by the secondary audio processor 406. The secondary audio processor 406 can be referred to as a control processor 502 in the context of FIG. 5.

As shown in FIG. 5, the control processor 502 can be configured to perform one or more tasks which can include:
i) speaker grouping 502a
ii) speaker crossover 502b
iii) speaker delay and directivity 502c

It is understood that not all of the tasks (i.e., I to iii) need to be carried out/performed. Specifically, the control processor 502 can be configured to perform any one or more of the tasks (i) to (iii), or any combination thereof. Moreover, the tasks need not necessarily be carried out/performed in the sequence outlined above.

From earlier discussion (i.e., FIG. 4), the control processor 502, which corresponds to the aforementioned secondary audio processor 406, can be coupled to the speaker driver module 316 (e.g., an amplifier). The speaker driver module 316 can be coupled to the speaker drivers 110.

Based on an earlier example, the speaker driver module 316 can be coupled to fifteen speaker drivers 110 (as represented by numerals “1” to “15” in FIG. 5).

The aforementioned left channel speaker driver array (e.g., in a TMM configuration) can be represented by numerals “4,” “5” and “6”. The aforementioned right channel speaker driver array (e.g., in a MMT configuration) can be represented by numerals “10,” “11” and “12”. The aforementioned center channel speaker driver array (e.g., in a MTM configuration) can be represented by numerals “7,” “8” and “9”. The aforementioned two additional channels (e.g., each having a MT speaker driver array configuration) can be represented by numerals “2,” “3” (i.e., for the first additional channel) and numerals “13,” “14” (i.e., for the second additional channel). The aforementioned yet further two channels (e.g., each having a full range speaker driver) can be represented by numeral “1” (i.e., for the first further channel) and numeral “15” (i.e., for the second further channel).

In this regard, in FIG. 5, it is appreciable that the “tweeter” speaker drivers can be represented by numerals “2,” “4,” “8,” “12” and “14”. The “Mid” speaker drivers can be represented by numerals “3,” “5,” “6,” “7,” “9,” “10,” “11,” and “13”. The full range speaker drivers can be represented by numerals “1” and “15”. It is further appreciable that each of the speaker drivers 110 is housed by an individual chamber. For example, speaker driver numeral “1” to speaker driver numeral “15” are housed by individual chamber 1a to individual chamber 15a respectively.

Moreover, it was mentioned earlier that the soundbar 100 can be paired with a subwoofer device. An example, as shown in FIG. 5, is a subwoofer device 504 which includes two speaker drivers 504a, 504b.

In regard to speaker grouping 502a, the control processor 502 can be configured to flexibly group the speaker drivers 110, in accordance with an embodiment of the disclosure. For example, the control processor 502 can be programmed (firmware etc.) to generate control signals so as to assign one or more speaker drivers 110 to a group.

In one example 506, the speaker drivers 110 can be grouped by the control processor 502 into seven groups (i.e., a first group 506a to a seventh group 506g). The first group 506a can include speaker driver numeral 1. The second group 506b can include speaker driver numerals 2 and 3. The third group 506c can include speaker driver numerals 4, 5 and 6. The fourth group 506d can include speaker driver numerals 7, 8 and 9. The fifth group 506e can include speaker driver numerals 10, 11 and 12. The sixth group 506f can include speaker driver numerals 13 and 14. The seventh group 506g can include speaker driver numeral 15.

In another example 508, the speaker drivers 110 can be grouped by the control processor 502 into seven groups (i.e., a first group 508a to a seventh group 508g). The first group 508a can include speaker driver numeral 1. The second group 508b can include speaker driver numerals 2 and 3. The third group 508c can include speaker driver numerals 4 and 5. The fourth group 508d can include speaker driver numerals 6, 7, 8, 9 and 10. The fifth group 508e can include speaker driver numerals 11 and 12. The sixth group 508f can include speaker driver numerals 13 and 14. The seventh group 508g can include speaker numeral 15.

Flexibly grouping of the speaker drivers 110 by the control processor 502 can have useful applications.

One exemplary application can be to boost audio output from a preferred (i.e., per user preference) segment of the soundbar 100. For example, it may be desired that the center channel segment of the soundbar 100 has a more weighted audio output as compared to the left and right channel segments. This can be achieved by configuring the control processor 502 to assign more speaker drivers to the center channel segment. Specifically, based on example 506 and example 508, it is appreciable that the fourth group 506d, 508d can be considered to be the center channel segment (whereas the third group 506c, 508c and the fifth group 506e, 508e can be considered to be the left channel segment and the right channel segment respectively). More specifically, comparing example 506 and example 508, it is appreciable that more speaker drivers (i.e., numeral 6 and numeral 10) have been assigned to the center channel segment in example 508. Therefore, the grouping arrangement based on example 508 would provide a more weighted audio output (i.e., boost in audio output) from the center channel segment as compared to the grouping arrangement based on example 506.

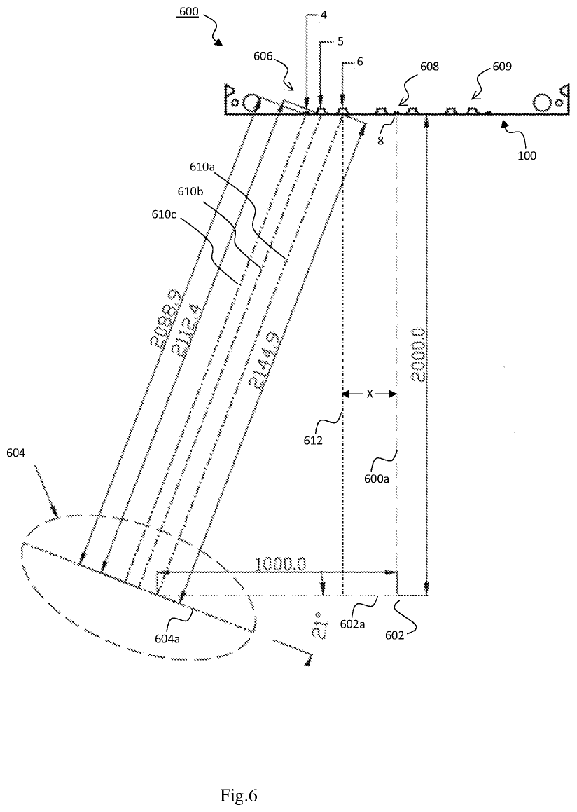

Another exemplary application can be to flexibly adjust one or more sound fields which can be responsible for providing a user (i.e., of the soundbar 100) with a “super-wide stereo” audible perception. Appreciably, given an exemplary soundbar 100 configuration of fifteen speaker drivers 110 paired with a two speaker driver subwoofer device 504, a “15.2 super-wide stereo” listening experience can be provided to a user. The sound field(s) will be discussed later in further detail with reference to FIG. 6.

In regard to speaker crossover 502b, it is appreciable that some of the speaker drivers 110 are more suitable for audio output of a certain range of audio frequencies whereas some of the speaker drivers 110 are more suitable for audio output of another certain range of audio frequencies. For example, a portion of the speaker drivers 110 can be high frequency based speaker drivers (i.e., “tweeter” speaker drivers) suitable for audio output of high frequency audio signals (e.g., above 4 KHz) and a portion of the speaker drivers 110 can be mid-frequency based speaker drivers (i.e., “Mid” speaker drivers) suitable for audio output of mid-range frequency audio signals (e.g., 100 Hz to 4 KHz). Therefore, the control processor 502 can, in accordance with an embodiment of the disclosure, be configured to perform the task of speaker crossover 502b so that appropriate audio signals can be output by appropriate speaker drivers 110 (e.g., audio signals above 4 KHz are to be output by “tweeter” speaker drivers such as numerals 4, 8 and 12, whereas audio signals from 100 Hz to 4 KHz to be output by “Mid” speaker drivers such as numerals 5, 6, 9, 10 and 11).

In regard to speaker delay and directivity 502c, the control processor 502 can, in accordance with an embodiment of the disclosure, be configured to perform the task of controlling direction of audio output of one or more speaker drivers 110 and providing a time delay in regard to the audio output of one or more speaker drivers 110. By performing the task of speaker delay and directivity 502c, one or more sound fields can be generated so as to facilitate “super-wide stereo” (e.g., “15.2 super-wide stereo”) audible perception. Moreover, as mentioned earlier, the option of flexibly grouping the speaker drivers 110 (i.e., in regard to speaker grouping 502a) can provide the possibility of flexibly adjusting the sound field(s).

The sound field(s) will be discussed in the context of an exemplary setup with reference to FIG. 6 hereinafter.

Referring to FIG. 6, an exemplary setup 600 is shown in accordance with an embodiment of the disclosure. A user 602 can be positioned 2000 millimeters (mm) away from the soundbar 100 and it is desired that a sound field 604, having a reference axis 604a, is generated at about 1000 mm to the left hand side of the user 602. Additionally, it is desired that the sound field 604 is offset at an angle of 21 degrees from a horizontal axis 602a extending from the user 602 towards the sound field 604. Moreover, the speaker driver numerals “4,” “5” and “6” can be grouped (i.e., assigned by the control processor 502) as a left channel segment 606 of the soundbar 100. Additionally, the speaker driver numerals “7,” “8” and “9” can be grouped (i.e., assigned by the control processor 502) as a center channel segment 608 of the soundbar 100. Moreover, the speaker driver numerals “10,” “11 and “12” can be grouped (i.e., assigned by the control processor 502) as a right channel segment 609 of the soundbar 100.

Specifically, as signified by line 600a (which is perpendicular to the soundbar 100 and cuts through the center channel segment 608) a user 602 can be facing the soundbar 100 and positioned approximately 2000 mm away from the soundbar 100. Further, as signified by horizontal axis 602a, a sound field 604 can be generated, based on the left channel segment 606, approximately 1000 mm (i.e., with reference to, for example, speaker driver numeral “6” which is closest, as compared to speaker driver numerals “4” and “5”, to the center channel segment 608) to the left of the user 602. In this regard, the speaker driver numeral “6” can also be referred to as a reference speaker driver to the remaining speaker drivers (e.g., numerals “4” and “5”) in the left channel segment 606 for the purpose of, for example, determining delay. Additionally, as signified by “X” (i.e., distance between lines 600a and 612), the reference speaker driver (i.e., speaker driver numeral “6” can be positioned 225 mm apart from the speaker driver numeral “8”. Moreover, as mentioned earlier, it is desired that the sound field 604 is offset at an angle of 21 degrees (i.e., intersection angle based on the reference axis 604a and the horizontal axis 602a).

Directivity of audio output from speaker driver numerals “6,” “5” and “4” can be represented by dotted lines 610a, 610b and 610c respectively. As shown, directivity of audio output from the speaker drivers 110 can, for example, be collimated based directivity output (i.e., the dotted lines 610a, 610b and 610c are substantially parallel with respect to each other). Dotted line 610a represents the distance between speaker driver numeral “6” and the reference axis 604a. Dotted line 610b represents the distance between speaker driver numeral “5” and the reference axis 604a. Dotted line 610c represents the distance between the speaker driver numeral “4” and the reference axis 604a.

The length of dotted line 610a can be determined to be 2144.9 mm based on Pythagoras theorem using the following lines:
A) line 612 (which is of equivalent length to line 600a which is 2000 mm); and
B) line 600b (which is 1000 mm) discounting “X” (which is 225 mm).

Specifically, length of dotted line 610a (i.e., 2144.9)=square root of: 2000²+(1000−225)^{2.}

In this regard, it is appreciable that the length of dotted line 610a can be determined based on the following parameters:
1) Distance between a user and the soundbar 100 (i.e., signified by line 600a)
2) Distance between the user and sound field 604 (i.e., signified by line 602a)
3) Distance between the reference speaker driver (speaker driver numeral “6”) and the speaker driver (speaker driver numeral “8”) through which line 600a cuts through.

Appreciably, the length of dotted lines 610b and 610c can be determined in an analogous manner. Since dotted lines 610b and 610c are based on speaker driver numeral “5” and speaker driver numeral “4” respectively, it is further appreciable that there is need to take into account their respective distances relative to speaker driver numeral “8”.

Based on this exemplary setup 600, the length of the dotted lines 610b and 610c can be determined to be 2112.4 mm and 2088.9 mm respectively.

Hence, to generate the sound field 604, the control processor 502 can be configured to perform:
1) the task of controlling direction of audio output of the speaker driver numerals “4,” “5” and “6”; and
2) providing a time delay, with reference to the reference speaker driver (i.e., speaker driver numeral “6”), in regard to the audio output of each of the speaker driver numeral “4” and the speaker driver numeral “5”.

Specifically, time delay should be provided for audio output of each of the speaker driver numeral “4” and the speaker driver numeral “5” so as to attain the aforementioned reference axis 604a which is offset at an angle of 21 degrees from a horizontal axis 602a extending from the user 602 towards the sound field 604.

The time delay to be applied in respect of the speaker driver numeral “4” is: (length of dotted line 610a minus length of dotted line 610c)/speed of sound. For example, ((2144.9−2088.9)/1000)/344=0.163 milliseconds (or approximately 8 samples at 48 KHz sampling rate which is equivalent to 8/48000).

The time delay to be applied in respect of the speaker driver numeral “5” is: (length of dotted line 610a minus length of dotted line 610b)/speed of sound. For example, ((2144.9−2112.4)/1000)/344=0.095 milliseconds (or approximately 5 samples at 48 KHz sampling rate which is equivalent to 5/48000).

Appreciably, the profile (i.e., as represented by dotted oval 604) of the sound field 604 is based on a non-converging type directivity output (i.e., where the outputs do not converge to one point). Preferably, the profile of the sound field 604 is based on collimated based directivity output where time delay is applied to the audio output of each of speaker driver numeral “4” (e.g., 0.163 milliseconds) and speaker driver numeral “5” (e.g., 0.095 milliseconds) so that, together with audio output from the speaker driver numeral “6”, the reference axis 604a can be formed (i.e., imaginary line drawn across, and connecting, the ends of dotted lines 610a, 610b and 610c).

Alternatively, a diverging based directivity output (i.e., where the outputs diverge and are non-collimated) is also possible. Appreciably, time delay and directivity for the speaker driver(s) of the left channel segment 606 would need to be adjusted accordingly so as to form the reference axis 604a, per earlier discussion concerning collimated based directivity output, in order to generate the sound field 604.

By generating a sound field based on a non-converging type directivity output (i.e., as opposed to converging to one point), the “sweet spot” for audible perception can be considerable enlarged. This is in contrast/comparison to converging type directivity output where there would be significantly higher requirement for precise user positioning for audible perception (i.e., limited “sweet spot” area). In this regard, the sound field 604 can be considered to be associable with a dispersed profile.

Additionally, although exemplary setup 600 has been discussed in much detail in the context of generating a sound field 604 by manner of appropriate adjustment(s) and/or control (i.e., controlling directivity and/or providing time delay(s)) of the left channel segment 606 by the control processor 502, it can be appreciated that one or more other sound fields can be generated.

For example, as with the left channel segment 606, the control processor 502 can, analogously, be further configured to control direction of audio output and provide appropriate time delay(s) in relation to one or more speaker drivers of the right channel segment 609 so as to generate another sound field to the right side of the user 602.

Hence it is appreciable that, in general, the soundbar 100 (i.e., which can be simply referred to as an apparatus) can include a plurality of speaker drivers 110 and a control processor 502.

The control processor 502 can be configured to:
1) flexibly group the speaker drivers 110 (i.e., into one or more groups such as the aforementioned left channel segment 606, center channel segment 608 and right channel segment 609)
2) perform the tasks of controlling directivity of audio output from at least one group (e.g., the left channel segment 606, the center channel segment 608 and/or the right channel segment 609) and providing time delay to audio output from at least one speaker driver (e.g., per exemplary setup 600, a time delay of 0.163 milliseconds is provided in connection with speaker driver numeral “4” and a time delay of 0.095 milliseconds is provided in connection with speaker driver numeral “5”) from at least one controlled group (e.g., per exemplary setup 600, the left channel segment 606 can be considered to be the controlled group since the control processor 502 is controlling/adjusting directivity of audio output from speaker driver numerals “6,” “5” and “4”) so as to generate at least one sound field 604 associable with a dispersed profile (i.e., the sound field 604 is considered to be based on a non-converging type directivity output).

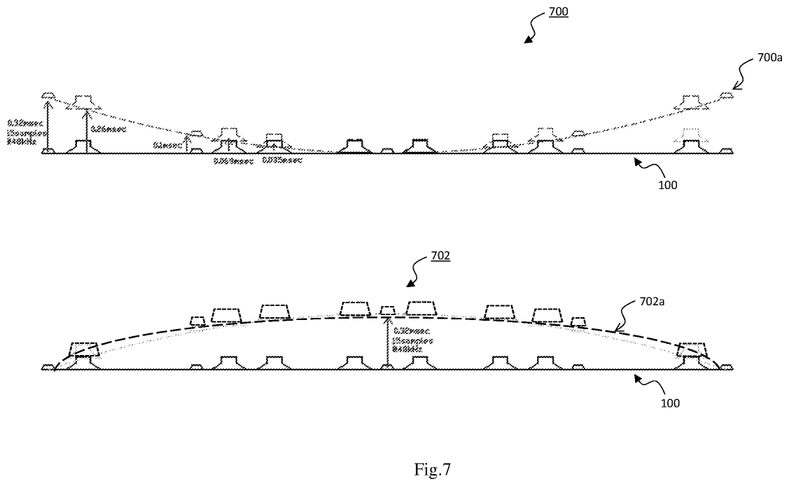

Appreciably, as shown in FIG. 7, based on exemplary setup 600, the control processor 502 controlling and/or adjusting the left and right channel segments 606, 609 would effectively result in a convex speaker arrangement/formation 700 (i.e., imaginary convex dotted depiction 700a), in accordance with an embodiment of the disclosure. It is appreciable that by appropriate adjustment and/or control of speaker drivers in the left, center and right channel segments 606, 608, 609, a concave speaker arrangement/formation 702 (i.e., imaginary concave dotted depiction 702a) can also be possible, in accordance with another embodiment of the disclosure.

The imaginary convex dotted depiction 700a and the imaginary concave dotted depiction 702a signify the effective audio output audibly perceivable by a user (i.e., although it may sound to a user like the speaker drivers 110 have been arranged in a convex/concave arrangement, but the speaker drivers 110 themselves need not necessarily be physically arranged/positioned as such).

Earlier mentioned, the soundbar 100 (i.e., which can be simply referred to as an apparatus) can be coupled to a computer for flexible control/adjustment of one or more data files (e.g., audio type files) played back by the soundbar 100.

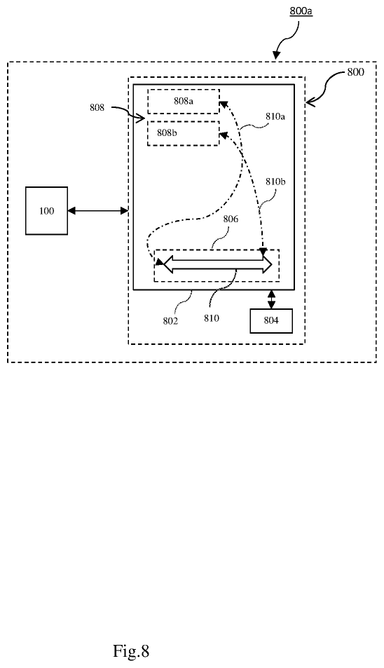

By flexibly controlling/adjusting the, for example, audio type file(s), a user can easily customize audio experience while using the soundbar 100. Effectively, user choreography in relation to audio output from the soundbar 100 can be facilitated. This will be discussed with reference to FIG. 8 hereinafter.

As shown in FIG. 8, the soundbar 100 can be coupled to a computer 800, according to an embodiment of the disclosure. Coupling between the soundbar 100 and the computer 800 can be by manner of one or both of wired coupling and wireless coupling. Moreover, the computer 800 can, for example, be either a desktop type computer (i.e., non-portable) or a portable type computer (e.g., a laptop computer, a processing unit, a handheld device such as a Smartphone or a Personal Digital Assistant).

Although the computer 800 can be a device which is external to the soundbar 100 (i.e., the soundbar 100 and the computer 800 are two distinctive/separate devices), the present disclosure contemplates that, as an option, the computer 800 can be carried by the soundbar 100 (e.g., the computer 800 can be in the form of an internal processing unit carried by the soundbar 100) or the soundbar 100 can be carried by the computer 800 (e.g., the soundbar 100 can correspond to an internal audio device carried by the computer 800). Specifically, as an option, the computer 800 and the soundbar 100 can be integrated. More specifically, as an option, the computer 800 and soundbar 100 can be considered as a single device. The soundbar 100 and the computer 800 can constitute an audio system 800a.

The computer 800 can include a display portion 802 and a control portion 804. In one embodiment, as shown, the display portion 802 can be non-touch screen based and the control portion 804 can be an input device (e.g., keyboard or a pointing device such as a mouse) which is coupled to the display portion 802 and which is usable by a user for generating control signals. In another embodiment, which is not shown, the display portion 802 can be touch screen based and can present the control portion 804 in the form of, for example, a Graphics User Interface which can be used by a user to generate control signals.

The computer 800 can be configured to present, via the display portion 802, a user interface 806 which allows a user to flexibly control/adjust one or more, for example, audio type files which can be played back by the soundbar 100. “Audio type file(s)” will be simply referred to as “audio file(s)” hereinafter.

Specifically, a user can, using the control portion 804, generate control signals so as to flexibly control/adjust one or more audio files. Moreover, the computer 800 can be configured to present, via the display portion 802, a suite of audio effects 808 for use by the user to flexibly control/adjust the audio file(s).

The suite of audio effects 808 can include one or more audio effects which can be preprogrammed (i.e., an audio library of sound effects, stored in the computer 800, ready for use by the user). The audio effects can be visually presented to a user as audio effect labels. For example, a first audio effect label 808a and a second audio effect label 808b are shown. Therefore, in general, the suite of audio effects 808 can include one or more audio effects which can be visually presented (i.e., via the display portion 802) as corresponding one or more audio effect labels 808a, 808b.

The first audio effect label 808a can correspond to an audio effect which can, for example, be labeled as “night mode”. The audio effect labeled as “night mode” can be associated to listening preferences during nighttime where there is a need for “soft” audio output (i.e., volume level for audio output is to be lower for during nighttime as compared to during daytime). The second audio effect label 808b can correspond to another audio effect which can, for example, be labeled as “Superwide Stereo”. “Superwide Stereo” has been discussed earlier with reference to FIG. 5 to FIG. 7.

In one embodiment, the user interface 806 can be configured to display a representation of an audio file. For example, a graphic representation (e.g., in the form of a timeline bar 810) of the duration of the audio output based on the audio file (e.g., duration of a song) and a user can be allowed to insert (e.g., via “drag and drop”) one or more audio effect labels from the suite of audio effects 808 at particular points in time of the duration of the audio output. Therefore, the user interface 806 can be configured to be usable by a user to assign one or more audio effects (e.g., the first audio effect label 808a/the second audio effect label 808b) to corresponding one or more portions of the audio file. Appreciably, it is also possible for a plurality of audio effect labels (e.g., both the first and second audio effect labels 808a, 808b) to be assigned to one portion of the audio file (i.e., as opposed to only one audio effect label being assigned to one portion of the audio file).

In one specific example, a user can drag and drop the first audio effect label 808a at the start of a song (i.e., at the beginning of the timeline bar 810, as depicted by dotted double arrow 810a) which has a duration of 6 minutes. The user can subsequently drag and drop the second audio effect label 808b one minute into the song (not shown), followed by both the first and second audio effect labels 808a, 808b four minutes (not shown) into the song and ending with the second audio effect label 808b (e.g., as depicted by dotted double arrow 810b) thirty seconds towards the end of the song.

In the above manner, a user can control what/which audio effect can be audibly perceived at which particular point in time of the audio output. Therefore, the user can be allowed to choreograph audio output (i.e., from the soundbar 100) per user preference.

Preferably, the audio file subjected to the user's choreography can be saved and replayed whenever desired (i.e., on the soundbar 100 or on another device such as the computer 800). By using the user interface 806 to insert audio effect label(s) 808a, 808b from the suite of audio effects 808 per earlier discussion, audio effect(s) can be considered to be embedded in the audio file.

An audio file having audio effect(s) embedded therein can be referred to as a “modified audio file”. In one example, audio effect(s) can be embedded in ID3 tag(s) of audio file(s) in a manner analogous to how lyrics can be embedded to an audio file (e.g., an audio file for a song played during a Karaoke session).

Alternatively, rather than by manner of embedding as discussed above, it is also possible to generate a companion file (i.e., to the audio file) based on the inserted audio effect label(s) 808a, 808b. The accompanying companion file can be generated and read/accessed in conjunction with the audio file in a manner analogous to how an accompanying subtitles file (e.g., “SubRip” type caption files which are named with the extension “.SRT”) for video file(s) can be generated and read/accessed.

Further preferably, the soundbar 100 and/or the computer 800 can be programmed (i.e., equipped with appropriate/proprietary firmware) so as to be capable of reading/accessing (e.g., decoding) such “modified audio file” and/or a combination of an audio file and its accompanying companion file.

Therefore, in an exemplary scenario where an audio file may be based on a recording of a long score played by an orchestra. It is appreciable that there could be certain parts of the score which may be audibly jarring to a listener (i.e., a user of the soundbar 100) and certain parts which the listener might prefer a wider stereo effect. In this regard, appropriate audio effect labels from the suite of audio effects 808 can be inserted in/at appropriate portions of the audio file via the user interface 806 presented. Moreover, soundstage (i.e., recreation of the recording of the musical event where the long score is played by the orchestra) can be flexibly changed per user preference via appropriate insertion of audio effect labels from the suite of audio effects 808. Appreciably, in general, each of the audio effect labels 808a, 808b can be capable of being flexibly inserted at any point in time within/of the timeline bar 810 so as to facilitating flexible choreography of audio output from the soundbar 100.

Therefore, by allowing a listener to choreograph audio output, of the recording of the long score, per user preference, the listener need not have to perform manual adjustments (e.g., turning the volume up or down) while listening to the playback of the, for example, long score via the soundbar 100. Appreciably, the need to perform manual adjustments during the course of playback may detract listening experience. Hence allowing the listener to choreograph audio output would, effectively, enhance listening experience.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

For example, although it is contemplated that the soundbar 100 can be coupled to a computer for flexible control/adjustment of one or more audio files played back by the soundbar 100 and FIG. 8 has been generally discussed in the context of audio type files, it is appreciable that such discussion can analogously apply to other general data files which can be associated with audio output(s). One such example is a video type file.

In a more specific example, the soundbar 100 can be coupled to a computer for flexible control/adjustment of one or more video type files played back in connection with the soundbar 100. Audio output associated with the video type file(s) can be output via the soundbar 100. It is contemplated that a video type file may contain audio which could be audibly jarring to a user and/or of more interest to a user. For example, a video type file can be an action film related video file and could include audio related to an explosion type sound effect and dialogues between actors/actresses. A user may find the explosion type sound effect to be audibly jarring and may prefer to concentrate more on the dialogues when watching the film. In this regard, the aforementioned “night mode” effect to be inserted during portions of the film where explosion sound effects can be heard and another audio effect (e.g., volume level boost) can be inserted during portions where the film is dialogue heavy.

1. An audio system comprising:
an apparatus carrying a plurality of speaker drivers; and
a computer, the computer being coupled to the apparatus and being configured to present a suite of audio effects and a user interface, the suite of audio effects and the user interface being usable to flexibly choreograph audio output, of a data file having audio content, from the apparatus,
wherein the suite of audio effects comprises one or more audio effects,
wherein the one or more audio effects can be flexibly inserted at any one point in time of the data file without affecting the audio content so as to flexibly choreograph audio output of the data file, and
wherein the computer can generate one or more sound fields to be reproduced by the plurality of speaker drivers and adjust the one or more sound fields.

2. The audio system as in claim 1,
wherein the user interface is configured to display a representation of the data file, the representation being in the form of a timeline bar, and
wherein the suite of audio effects comprises one or more audio effects which can be visually presented as corresponding one or more audio effect labels.

3. The audio system as in claim 2, wherein each of the audio effect labels is capable of being flexibly inserted at any point in time of the timeline bar, thereby facilitating flexible choreography of audio output from the apparatus.

4. The audio system as in claim 3, wherein each of the audio effect labels is capable of being flexibly inserted at any point in time of the timeline bar by drag and drop.

5. The audio system as in claim 1, wherein the one or more audio effects is embedded in the audio file or generated as a companion file.

6. The audio system as in claim 1, wherein the computer is configured to flexibly group the plurality of speaker drivers in different configurations to generate the one or more sound fields.
